(19) United States
(12) Patent Application Publication
(10) Pub. No.: US 2025/0353384 A1
(43) Pub. Date: Nov. 20, 2025

(54) POWER STORAGE DEVICE

(71) Applicant: TOYOTA JIDOSHA KABUSHIKI KAISHA, Aichi-ken (JP)

(72) Inventors: Kenichi KAKISHITA, Nagoya-shi (JP); Shigeyuki INOUE, Toyota-shi (JP); Naoya KAWAMOTO, Nisshin-shi (JP); Takahito SAKURABA, Seto-shi (JP); Kohei TAKASE, Susono-shi (JP); Kai MIYAMURA, Toyota-shi (JP); Kazuya KUMAZAWA, Nagoya-shi (JP)

(21) Appl. No.: 19/096,722

(22) Filed: Apr. 1, 2025

(30) Foreign Application Priority Data
May 15, 2024 (JP) 2024-079621

(51) Int. Cl. B60L 50/64; B60L 50/60; H01M 50/211; H01M 50/242; H01M 50/249; H01M 50/502

(52) U.S. Cl. CPC B60L 50/64; B60L 50/66; H01M 50/211; H01M 50/242; H01M 50/249; H01M 50/502; H01M 2220/20

(57) ABSTRACT

In a power storage device, a plurality of power storage modules is arranged side by side in a vehicle left-right direction. A plurality of cell units is arranged side by side in a vehicle front-rear direction. A connection portion connects cell units on both sides thereof. A module case accommodates the cell units and the connection portion. The connection portions of the power storage modules are arranged side by side in the left-right direction. The side wall portion is located on one side in the left-right direction of the power storage modules. A reinforcing portion protrudes from the side wall portion toward the power storage modules in the left-right direction. The reinforcing portion is further aligned in the left-right direction with the connection portion of each of the power storage modules arranged side by side in the left-right direction.

### CROSS-REFERENCE TO RELATED APPLICATION

This application claims priority to Japanese Patent Application No. 2024-079621 filed on May 15, 2024, incorporated herein by reference in its entirety.

### BACKGROUND

### 1. Technical Field

The disclosure relates to a power storage device.

### 2. Description of Related Art

Japanese Unexamined Patent Application Publication No. 2020-142589 (JP 2020-142589 A) discloses that a battery pack is disposed on a lower side of a floor panel.

### SUMMARY

A power storage device (battery pack) having a larger energy capacity has been demanded as a power storage device to be mounted in a vehicle. For this reason, there has been considered such a power storage device that is equipped with a number of module cases each including a number of cell units therein. For example, a number of module cases may be laid down to be arranged side by side in a left-right direction of a vehicle.

With respect to a power storage device having the configuration as described above, there is a high possibility that deformation of a module case makes cell units in the module case bend in the event of a side impact on a vehicle, which may result in damage to the cell units.

The present disclosure has been made in consideration of the above problem, and has an object to provide a power storage device that can restrain cell units inside a module case from being damaged when a vehicle is subjected to a side impact.

A power storage device according to an aspect of the present disclosure is a power storage device to be mounted in a vehicle. The power storage device includes a plurality of power storage modules and a case. The power storage modules are arranged in a left-right direction of the vehicle. The case accommodates the power storage modules. Each of the power storage modules includes a plurality of cell units, at least one connection portion, and a module case. The cell units are arranged in a front-rear direction of the vehicle. The connection portion is arranged between adjacent cell units of the plurality of cell units. The connection portion connects cell units on both sides thereof. A module case accommodates the cell units and the connection portion. The connection portions of the power storage modules are arranged side by side along the left-right direction. The case includes a side wall portion and a reinforcing portion. The side wall portion is located on one side in the left-right direction of the power storage modules. The reinforcing portion protrudes from the side wall portion toward the power storage modules along the left-right direction. The reinforcing portion is further aligned in the left-right direction with the connection portion of each of the power storage modules arranged side by side in the left-right direction.

In the power storage device according to the aspect of the present disclosure, each of the cell units may include an electrode body. The reinforcing portion may be provided so as not to be aligned with each of the electrode bodies of the cell units in the left-right direction.

In the power storage device according to the aspect of the present disclosure, in each of the power storage modules, the cell units may include three or more cell units. In each of the power storage modules, at least one connection portion may include a first connection portion and a second connection portion. The second connection portion may connect at least one of cell units connected to the first connection portion to a different cell unit. The first connection portions of the power storage modules may be arranged side by side along the left-right direction. The second connection portions of the power storage modules may be arranged side by side along the left-right direction. The reinforcing portion may include a first end portion that is one end portion in the front-rear direction, and a second end portion that is the other end portion in the front-rear direction. The first end portion may be aligned with the first connection portion of each of the power storage modules in the left-right direction. The second end portion may be aligned with the second connection portion of each of the power storage modules in the left-right direction.

In the power storage device according to the aspect of the present disclosure, in each of the power storage modules, the cell units may include a first cell unit, a second cell unit, a third cell unit, and a fourth cell unit. In each of the power storage modules, the first connection portion may connect the first cell unit and the second cell unit to each other. In each of the power storage modules, the second connection portion may connect the third cell unit and the fourth cell unit to each other.

According to the present disclosure, it is possible to restrain the cell units inside the module case from being damaged when the vehicle is subjected to a side impact.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a vehicle equipped with a power storage device according to an embodiment 1 of the present disclosure;

FIG. 2 is a sectional view of a part of the vehicle and the power storage device in FIG. 1 as viewed in the direction of an arrow line II-II;

FIG. 3 is a plan view that partially shows the power storage device according to the embodiment 1;

FIG. 4 is a plan view that schematically shows the state of the power storage device according to the embodiment 1 when the vehicle is subjected to a side impact;

FIG. 5 is a plan view that partially shows a power storage device according to an embodiment 2; and

FIG. 6 is a plan view that schematically shows the state of the power storage device according to the embodiment 2 when the vehicle is subjected to a side impact.

### DETAILED DESCRIPTION OF EMBODIMENTS

A power storage device according to each embodiment of the present disclosure will be described hereunder with reference to the drawings. The same or corresponding components in the drawings are designated by the same reference signs and the description thereon will not be repeated.

Furthermore, arrows F, B, U, D, L, and R in figures used in the following description indicate directions with respect to a vehicle, wherein the arrow F indicates “forward,” the arrow B indicates “backward,” the arrow U indicates “upward,” the arrow D indicates “downward,” the arrow L indicates “leftward,” and the arrow R indicates “rightward”.

### Embodiment 1

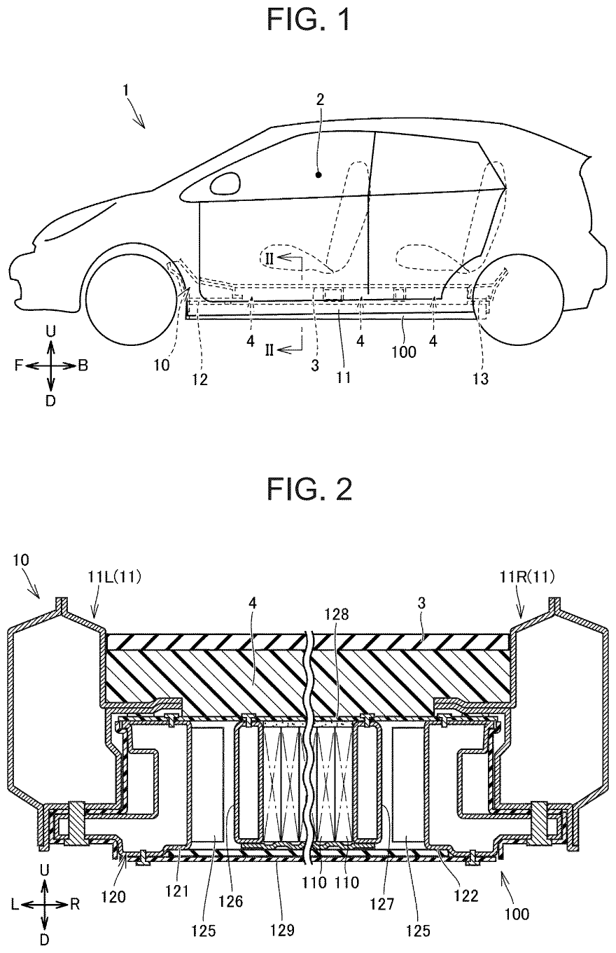

FIG. 1 is a diagram showing a vehicle in which a power storage device according to an embodiment 1 of the present disclosure is mounted. FIG. 2 is a sectional view of a part of the vehicle and the power storage device in FIG. 1 as viewed in the direction of an arrow line II-II. As shown in FIGS. 1 and 2, the power storage device 100 according to the first embodiment of the present disclosure is a power storage device 100 equipped in a vehicle 1.

A vehicle 1 in which the power storage device 100 can be mounted will be described. The vehicle 1 is, for example, an electrified vehicle that can be driven by a motor, such as a battery electric vehicle or a hybrid electric vehicle. The vehicle 1 includes a vehicle cabin 2 above the power storage device 100.

The vehicle 1 may further include a floor carpet 3 and a cushioning member 4. The floor carpet 3 demarcates the vehicle cabin 2. The cushioning member 4 is disposed below the floor carpet 3. The cushioning member 4 is lighter in weight than metal, and may be made of a material that is softer than metal. The cushioning member 4 is made of a material including, for example, a foamed resin.

The vehicle 1 includes a vehicle frame 10. The power storage device 100 may be mounted below the vehicle frame 10. The vehicle frame 10 includes a pair of side members 11, a front member 12, and a rear member 13. The vehicle frame 10 does not necessarily include a floor panel that demarcates the vehicle cabin 2.

The pair of side members 11 extend in a vehicle front-rear direction. The pair of side members 11 are located on both sides of the center of the vehicle 1 in a vehicle width direction, respectively. The pair of side members 11 include a left side member 11L and a right side member 11R. The left side member 11L is located on a left side of the center of the vehicle 1 in the vehicle width direction. The right side member 11R is located on a right side of the center of the vehicle 1 in the vehicle width direction.

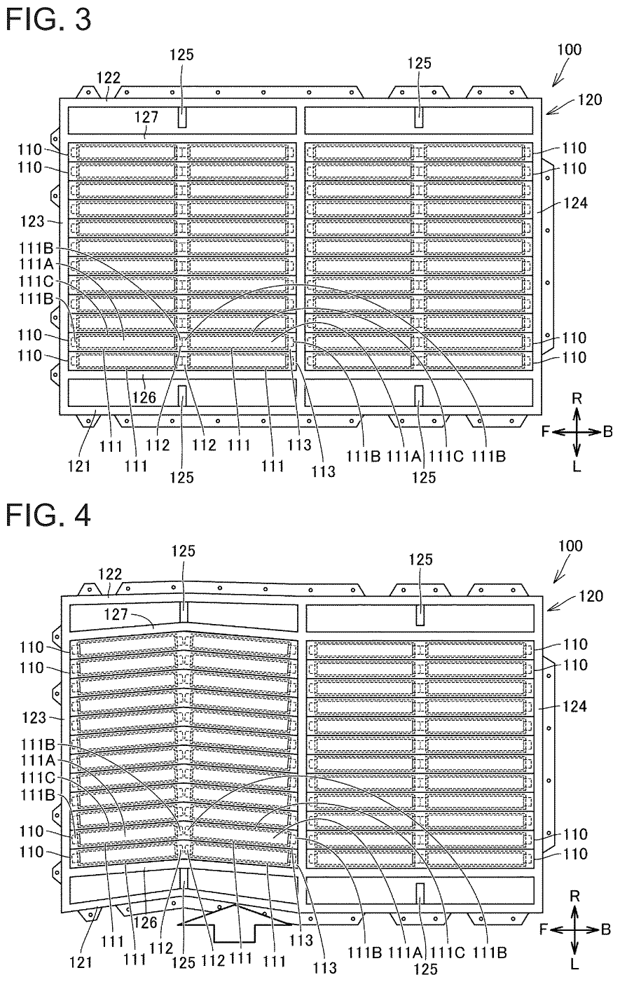

Next, the power storage device 100 will be described. FIG. 3 is a plan view that partially shows the power storage device according to the embodiment 1.

The power storage device 100 includes a plurality of power storage modules 110 and a case 120. The power storage modules 110 are arranged side by side in the left-right direction of the vehicle 1. The case 120 accommodates the power storage modules 110.

In the present embodiment, two module groups each of which is configured by a plurality of power storage modules 110 arranged side by side in the left-right direction of the vehicle 1 are accommodated in the case 120. The two module groups are arranged in the front-rear direction.

Each of the power storage modules 110 has a substantially rectangular parallelepiped outer shape. The longitudinal direction of each of the power storage modules 110 is a direction along the front-rear direction of the vehicle 1. Each of the power storage modules 110 includes a plurality of cell units 111, at least one connection portion 112, and a module case 113.

An example of the cell unit 111 is a lithium ion battery. The cell unit 111 may be configured as a so-called all-solid-state battery that includes a solid electrolyte.

In the module case 113, the cell units 111 are arranged side by side in the front-rear direction of the vehicle 1. There is no particular limit to the number of cell units 111 in the module case 113. In the module case 113, the cell units 111 may be further arranged side by side in the left-right direction of the vehicle 1, or may be further arranged side by side in an up-down direction of the vehicle 1.

Each cell unit 111 may include, for example, an electrode body 111A, a current collecting terminal 111B, and a laminated exterior body 111C.

The electrode body 111A is configured by a wound body in which a cathode sheet and an anode sheet are wound with a separator interposed therebetween. However, each electrode body 111A may be configured by a laminate in which a cathode sheet and an anode sheet are laminated with a separator interposed therebetween.

The current collecting terminal 111B is connected to the electrode body 111A. The current collecting terminal 111B protrudes from the electrode body 111A in the front-rear direction. The current collecting terminal 111B that is electrically connected to the anode electrode sheet of the electrode body 111A is made of, for example, aluminum. The current collecting terminal 111B that is electrically connected to the anode electrode sheet of the electrode body 111A is made of, for example, copper.

The laminated exterior body 111C accommodates the electrode body 111A and a part of the current collecting terminal 111B. The laminated exterior body 111C is formed of a laminate film. The current collecting terminal 111B protrudes outward in the front-rear direction from an edge of the laminated exterior body 111C.

The connection portion 112 is disposed between adjacent cell units 111 of the plurality of cell units 111. The connection portion 112 connects the cell units 111 on both sides thereof. Specifically, the connection portion 112 is a portion where the current collecting terminals 111B of the cell units 111 on both sides of the connection portion 112 are connected to each other on the outside of the laminated exterior body 111C.

The module case 113 accommodates the cell units 111 and the connection portions 112. The module case 113 has a substantially rectangular parallelepiped outer shape. The module case 113 is made of stainless steel, aluminum, or an aluminum alloy.

The power storage modules 110 are arranged such that the connection portions 112 of the power storage modules 110 arranged side by side in the left-right direction are arranged side by side along the left-right direction.

The case 120 includes a side wall portion 121 (first side wall portion), a second side wall portion 122, a front wall portion 123, a rear wall portion 124, reinforcing portions 125, a first inner wall portion 126, and a second inner wall portion 127. Each of the above-mentioned portions of the case 120 is formed of metal such as stainless steel or an aluminum alloy. Furthermore, the above-mentioned portions of the case 120 may be formed integrally with one another.

The side wall portion 121 is located on one side in the left-right direction of the power storage modules 110. The second side wall portion 122 is located on the other side in the left-right direction of the power storage modules 110. The side wall portion 121 and the second side wall portion 122 extend along the front-rear direction of the vehicle 1. The side wall portion 121 and the second side wall portion 122 are fixed to the side members 11 on both sides, respectively.

The front wall portion 123 is located forward of the power storage modules 110. More specifically, the front wall portion 123 is located further forward of the module group on the front side. The front wall portion 123 extends in the left-right direction of the vehicle 1. The front wall portion 123 is connected to front end portions of the side wall portion 121 and the second side wall portion 122.

The rear wall portion 124 is located rearward of the power storage modules 110. More specifically, the rear wall portion 124 is located further rearward of the module group on the rear side. The rear wall portion 124 extends in the left-right direction of the vehicle 1. The rear wall portion 124 is connected to rear end portions of the side wall portion 121 and the second side wall portion 122.

The reinforcing portions 125 protrude in the left-right direction from the side wall portion 121 toward the power storage modules 110. The reinforcing portions 125 are further aligned in the left-right direction with the respective connection portions 112 of the power storage modules 110 arranged side by side in the left-right direction. The reinforcing portions 125 are provided so as not to be aligned in the left-right direction with the respective cell units 111 of the power storage modules 110.

In the present embodiment, the case 120 may include a plurality of reinforcing portions 125. For example, other reinforcing portions 125 different from the above-mentioned reinforcing portions 125 among the plurality of reinforcing portions 125 may protrude in the left-right direction from the second side wall portion 122 toward the power storage modules 110.

The first inner wall portion 126 is located between the power storage modules 110 and the side wall portion 121. The first inner wall portion 126 is spaced apart from the side wall portion 121. The first inner wall portion 126 extends along the front-rear direction of the vehicle 1. Both ends of the first inner wall portion 126 in the front-rear direction are connected to the front wall portion 123 and the rear wall portion 124, respectively. The first inner wall portion 126 is spaced apart from the reinforcing portions 125 extending from the side wall portion 121, but may be in contact with the reinforcing portions 125.

The second inner wall portion 127 is spaced apart from the second side wall portion 122. The second inner wall portion 127 extends along the front-rear direction of the vehicle 1. Both ends of the second inner wall portion 127 in the front-rear direction are connected to the front wall portion 123 and the rear wall portion 124, respectively. The second inner wall portion 127 is spaced apart from the reinforcing portions 125 extending from the second side wall portion 122, but may be in contact with the reinforcing portions 125.

The case 120 may include an upper wall portion 128 and a lower wall portion 129. The upper wall portion 128 covers the upper sides of the power storage modules 110. The upper wall portion 128 may be, for example, carbon fiber reinforced plastics (CFRP). The upper wall portion 128 may be in contact with the cushioning member 4. The lower wall portion 129 covers the lower sides of the power storage modules 110. The lower wall portion 129 may have, for example, a cooling function for cooling the power storage modules 110.

As described above, the power storage device 100 according to the embodiment 1 of the present disclosure is a power storage device 100 to be mounted in a vehicle 1. The power storage device 100 includes a plurality of power storage modules 110 and a case 120. The power storage modules 110 are arranged side by side in the left-right direction of the vehicle 1. The case 120 accommodates the power storage modules 110. Each of the power storage modules 110 includes a plurality of cell units 111, at least one connection portion 112, and a module case 113. The cell units 111 are arranged side by side in the front-rear direction of the vehicle 1. The connection portion 112 is disposed between adjacent cell units 111. The connection portion 112 connects the cell units 111 on both sides thereof. The module case 113 accommodates the cell units 111 and the connection portion 112. The respective connection portions 112 of the power storage modules 110 are arranged side by side in the left-right direction. The case 120 includes a side wall portion 121 and reinforcing portions 125. The side wall portion 121 is located on one side in the left-right direction of the power storage modules 110. The reinforcing portions 125 protrude in the left-right direction from the side wall portion 121 toward the power storage modules 110. The reinforcing portions 125 are further aligned in the left-right direction with the respective connection portions 112 of the power storage modules 110 arranged side by side in the left-right direction.

FIG. 4 is a plan view that schematically shows a state of the power storage device according to the embodiment 1 when the vehicle is subjected to a side impact. As shown in FIG. 4, when the vehicle 1 is subjected to a side impact, the side wall portion 121 is pushed inward from the outside in the left-right direction. At this time, the side wall portion 121 is bent around a portion where the reinforcing portion 125 is provided. This reinforcing portion 125 is pushed toward the power storage modules 110. With respect to a plurality of power storage modules 110 pushed by the reinforcing portion 125, the module cases 113 are bent around the connection portions 112 due to the above-mentioned configuration. As a result, a plurality of cell units 111 inside the module cases 113 can be restrained from bending. Therefore, when the vehicle 1 is subjected to a side impact, the cell units 111 inside the module cases 113 can be restrained from being damaged.

Each of the cell units 111 includes the electrode body 111A. The reinforcing portions 125 are provided so as not to be aligned with each of the electrode bodies 111A in the left-right direction.

According to the configuration described above, when the vehicle 1 is subjected to a side impact, it is possible to restrain the module cases 113 from bending in regions where the electrode bodies 111A are accommodated due to the pushing of the reinforcing portions 125. As a result, it is possible to further restrain the cell units 111 inside the module cases 113 from being damaged.

### Embodiment 2

Next, a power storage device according to an embodiment 2 of the present disclosure will be described. The power storage device according to the embodiment 2 differs from the power storage device 100 according to the embodiment 1 mainly in the configurations of the power storage module and the reinforcing portion. Therefore, the description on the configuration similar to that of the power storage device 100 according to the embodiment 1 will not be repeated.

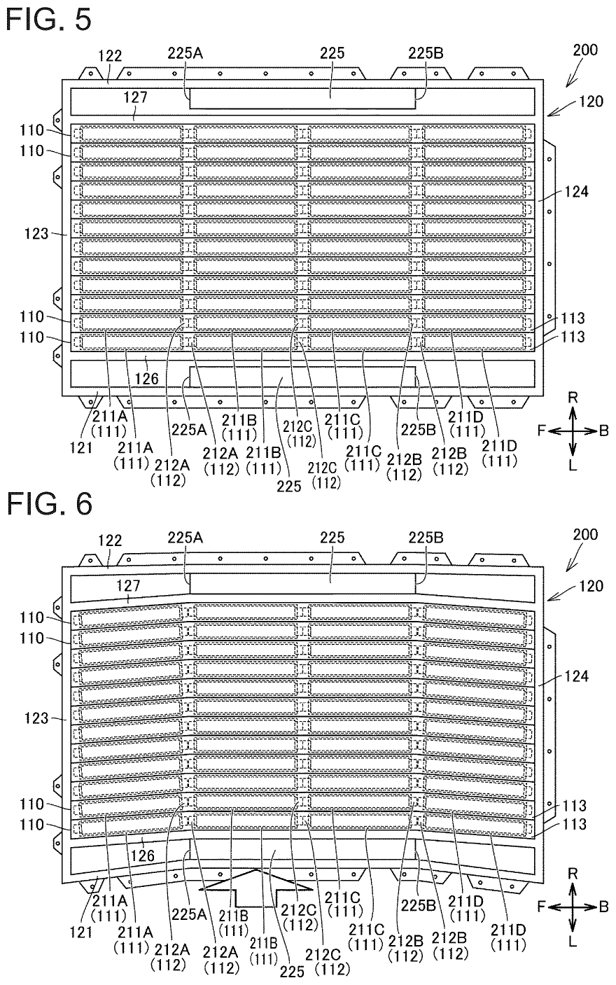

FIG. 5 is a plan view that partially shows the power storage device according to the embodiment 2. As shown in FIG. 5, in the power storage device 200 according to the embodiment 2 of the present disclosure, the cell units 111 in each of the power storage modules 110 include three or more cell units 111.

In each of the power storage modules 110, at least one connection portion 112 includes a first connection portion 212A, a second connection portion 212B, and a third connection portion 212C.

The third connection portion 212C connects at least one of the cell units 111 connected to the first connection portion 212A to a different cell unit 111. The first connection portions 212A of the power storage modules 110 are arranged side by side along the left-right direction. The second connection portions 212B of the power storage modules 110 are arranged side by side along the left-right direction. The reinforcing portion 225 includes a first end portion 225A that is one end portion in the front-rear direction, and a second end portion 225B that is the other end portion in the front-rear direction.

The first end portion 225A is aligned in the left-right direction with the first connection portions 212A of the power storage modules 110. The second end 225B is aligned in the left-right direction with the second connection portions 212B of the power storage modules 110.

FIG. 6 is a plan view that schematically shows a state of the power storage device according to the embodiment 2 when the vehicle is subjected to a side impact. According to the above configuration, as shown in FIG. 6, when the vehicle 1 is subjected to a side impact, the module cases 113 bend at two locations where the first connection portion 212A and the second connection portion 212B corresponding to the first end portion 225A and the second end portion 225B are located. The module cases 113 bend at two locations, which makes it possible to restrain the displacement of the power storage modules 110 in the left-right direction. Furthermore, the module cases 113 bend at two locations where the first connection portion 212A and the second connection portion 212B are located, which makes it possible to further restrain damage to the cell units 111.

More specifically, according to the power storage device 200 of the embodiment 2 of the present disclosure, in each of the power storage modules 110, the cell units 111 include a first cell unit 211A, a second cell unit 211B, a third cell unit 211C, and a fourth cell unit 211D. In each of the power storage modules 110, the first connection portion 212A connects the first cell unit 211A and the second cell unit 211B to each other. In each of the power storage modules 110, the second connection portion 212B connects the third cell unit 211C and the fourth cell unit 211D to each other.

According to the above configuration, when the reinforcing portion 225 is pressed toward the power storage modules 110 as shown in FIG. 6, the pressing of the reinforcing portion 225 against the power storage modules 110 can be entirely received by the cell units 111. Specifically, this pressing can be entirely received by the first cell unit 211A or the second cell unit 211B and the third cell unit 211C or the fourth cell unit 211D. As a result, damage caused by bending of the cell units 111 can be further restrained.

More specifically, an end face of the reinforcing portion 225 in the embodiment 2, the end face being located on the side of the power storage modules 110, extends along the front-rear direction of the vehicle 1. Furthermore, in each of the power storage modules 110, the third connection portion 212C connects the second cell unit 211B and the third cell unit 211C to each other. The third connection portions 212C of the power storage modules 110 are also arranged side by side along the left-right direction. The pressing of the reinforcing portion 225 against the power storage modules 110 is received by the second cell units 211B and the third cell units 211C.

In the foregoing descriptions on the embodiments, combinable configurations may be combined with each other.

The embodiments disclosed herein should be considered to be illustrative and nonrestrictive in all respects. The scope of the present disclosure is defined, not by the foregoing descriptions, but by the claims, and is intended to include meanings equivalent to the scope of the claims and all modifications within the scope of the claims.

What is claimed is:

1. A power storage device to be mounted in a vehicle, the power storage device comprising:
a plurality of power storage modules arranged in a left-right direction of the vehicle; and
a case that accommodates the power storage modules,
wherein each of the power storage modules includes:
a plurality of cell units arranged in a front-rear direction of the vehicle;
at least one connection portion that is arranged between adjacent cell units of the plurality of cell units and connects the cell units on both sides thereof; and
a module case that accommodates the cell units and the connection portion, the connection portions of the power storage modules being arranged side by side along the left-right direction,
wherein the case includes:
a side wall portion located on one side in the left-right direction of the power storage modules; and
a reinforcing portion protruding from the side wall portion toward the power storage modules along the left-right direction, and
wherein the reinforcing portion is further aligned in the left-right direction with the connection portion of each of the power storage modules arranged in the left-right direction.

2. The power storage device according to claim 1, wherein each of the cell units includes an electrode body, and the reinforcing portion is arranged so as not to be aligned with each of the electrode bodies of the cell units in the left-right direction.

3. The power storage device according to claim 1, wherein:
in each of the power storage modules, the cell units include three or more cell units;
in each of the power storage modules, at least one of the connection portions includes a first connection portion and a second connection portion that connects at least one of cell units connected to the first connection portion to a different cell unit;
the first connection portions of the power storage modules are arranged side by side along the left-right direction;
the second connection portions of the power storage modules are arranged side by side along the left-right direction;
the reinforcing portion includes a first end portion that is one end portion in the front-rear direction, and a second end portion that is the other end portion in the front-rear direction;
the first end portion is aligned with the first connection portion of each of the power storage modules in the left-right direction, and
the second end portion is aligned with the second connection portion of each of the power storage modules in the left-right direction.

4. The power storage device according to claim 3, wherein:
in each of the power storage modules, the cell units include a first cell unit, a second cell unit, a third cell unit, and a fourth cell unit;
in each of the power storage modules, the first connection portion connects the first cell unit and the second cell unit to each other; and
in each of the power storage modules, the second connection portion connects the third cell unit and the fourth cell unit to each other.
